(19) United States
(12) Patent Application Publication
(10) Pub. No.: US 2009/0304885 A1
(43) Pub. Date: Dec. 10, 2009

(54) Coffee and Tea Baking Compounds and Method of Producing The Same

(76) Inventor: John R. Perry, St. Johns, FL (US)

Correspondence Address: John Perry, 431 Briar Pl., Libertyville, IL, 60048, US

(21) Appl. No.: 12/134,216

(22) Filed: Jun. 6, 2008

(51) Int. Cl. A23L 3/3463; A21D 6/00; A23F 5/48; A23F 3/42

(52) U.S. Cl. 426/321; 426/429; 426/496; 426/518

(57) ABSTRACT

The present application describes coffee and tea-baking compounds and method for producing the same.

### FIELD OF THE INVENTION

The present invention relates to a process and method for producing a coffee and tea baking compound and then mixing the compounds with other ingredients to form baked goods and food stuffs.

### SUMMARY OF INVENTION

One embodiment, the invention describes combinations of ingredients comprising of ground coffee or tea then mixing with vegetable oils or animal fats to produce a baking compound. In a more particular embodiment the invention describes combinations of ingredients and/or baking methods used to preserve the polyphenol or antioxidant content of baked goods or ingredients. It is also desirable to preserve as many nutritional and functional properties of the ingredients to maintain the overall value of the finished baked goods. This is becoming increasingly important in light of the antioxidant content of coffee, tea and the positive health effects that can be attributed to antioxidants in foods.

### FIELD OF THE INVENTION AND RELATED BACKGROUND

1. The present invention relates to a coffee and tea baking compound and method of producing the same. The compound is derived from ground coffee or tea and mixing it with vegetable oils or any animal fats to produce said baking compound. The invention further relates to polyphenols being a major flavor producer when associated with the Maillard reaction (MR) developing new flavor pathways. The invention further relates to polyphenols and how they increase product shelve life and aid in helping the human body's cells resist damage by free radicals.

2. Recent research also indicates that polyphenols have been identified as major flavor producers, or associated with the (MR) reaction. Further analysis show that the polyphenols inhibit the Maillard reaction by tying up or quenching some of the sugars and other transient reaction products the process needs to proceed. Further samples indicate that added polyphenols developed a lower level of (MR) reaction type aroma compounds as measured by gas chromatography and a panel of trained human sniffers. The (MR) reaction not only produces desirable changes such as golden brown color and toasty aroma, but also can also sometimes cause off-flavors or stale odors. The Maillard not only proceeds during roasting and baking but also during storing. (Dr. Devin Peterson Penn state Jan. 29, 2005)

3. Recent studies show that polpyenols reduce levels of acrylamide such additives ideally combine acryl amide reduction with little or no changes in product technology or sensory quality. Acryl amide is a carcinogen that is created when starchy foods are baked, roasted, fried or toasted. The Swedish Food Administration first reported unexpectedly high levels of acryl amide found to cause cancer in laboratory rats in carbohydrate rich foods. Source: Journal of Cereal Science (Elsevier) March 2008, Volume 47, Issue 2, Pages 118-133 “Acryl amide in cereal products: A review” Authors: A. Claus, R. Carle, A. Schieber

4. Recent research indicates that polyphenols in coffee and tea plants possess the capacity for diversified, beneficial pharmacological activities. It is widely accepted that these compounds possess a wide range of beneficial pharmacological activities, which include stabilizing the capillary wall tissues, quenching free radicals, maintaining proper permeability and flexibility of capillaries, and preventing cardiovascular diseases.

5. Numerous studies have also shown that most plant polyphenols possess cancer preventive capacity because of their profound antioxidant activity. (C. Castelluccio, et al FEBS letters 368 (1995) 188-192)

6. Current research shows that the suspicion over chemical-derived synthetic preservatives has pushed food makers to source natural preservative extracts from microbial-fermented Purer tea and Fuzhuan brick-tea have the potential to inhibit several food-borne bacteria, including Bacillus cereus, Bacillus subtilis, Clostridium perfringens and Clostridium sporogenes. Tea extracts can be industrialized as alternatives to synthetic preservatives such as like butylhydroxyanisole (BHA) and butylhydroxytoluene (BHT) to slow down the oxidative deterioration of food. (Source: Trends in Food Science & Technology (Elsevier) Published on-line ahead of print, doi: 10.1016/j.tifs.2007.10.001 “Microbial fermented tea—a potential source of natural food preservatives” (Authors: H. Mo, Y. Zhu, Z. Chen)

7. The present invention demonstrates that the formulation of new baking products with the availability of ascorbic acid could protect catechins from digestive degradation. Studies show that teas rich in catechins are associated with reduced risk of stomach, colon and other gastrointestinal cancers. The studies further indicate that the digestive process could both alter the structure of the tea catechins and their anticancer activity. using a model simulating gastric and small-intestinal digestion, the researchers treated gastric cancer cells and colon cancer cell lines with digested and undigested (parent) extracts of green, tea, black tea, and a combination of the most active tea catechins (EGCG/EGC). In colon cells, digestion of both the green tea extracts and the catechin combination significantly reduced anticancer activity compared to undigested parent extracts. Black tea, on the other hand, showed the same anticancer activity for both parent and digested extracts. Digestion and the type of tea made a difference in terms of anticancer activity. In addition, the anticancer activity of the tea extracts differed between gastric and colon cancer cell lines. In gastric cancer cells the undigested extracts were 50 percent less effective than in colon cancer cells. (Fabiola Gutierrez Orozco PHYSORG biology Apr. 7, 2008)

8. Phenolic acids in coffee are mainly esters of quinic acid with different amount of caffeyl groups attached to its different positions. The phenolic acids present in coffee such as chlorogenic acid, caffeic acid, and para-coumaric acid have been shown to exert cancer preventive activities in animal models. Chlorogenic acid has also been found to inhibit methylazoxymethanol-induced large intestinal tumors in hamster.(Huang,et al.,Cancer Research 48,5941-5946 (Nov. 1, 1988)).

9. Studies show the pleasant fresh sulfury coffee aroma quality that we have come to admire in coffee suffers during storage and it simply cannot be preserved. This is mainly due to the decrease of the coffee like smelling compound 2-furfurylthiol (FFT). Recent studies have shown that di and trihydroxybenzenes and some particular hydroxyhydroquinones, react with FFT and other odor-active thiols such as methanethiol that are present in freshly brewed coffee. The reactions form conjugates, including 4-[(2-furylmethyl)sulfanyl]hydroxyhydroquinone. This oxidative coupling begins right after coffee is brewed and continues when the beverage is kept hot or processed into canned, instant or concentrated liquid coffee. The binding reactions which end when all the odor-active thiols are trapped explain why the smell of the stored beverage isn't as appealing as the alluring aroma of freshly brewed coffee. Recent studies concluded that by lowering the oxygen level in coffee, or controlling the parameters such as pH during the extraction of coffee powder would improve shelf life and flavor. (Chemical & Engineering News ISSN 0009-2347 American Chemical Society, Jürg Baggenstoss)

10. Recent studies on antibacterial activity of coffee extracts and selected coffee chemical compounds against enterobacteria caffeine, chlorogenic acid and protocatechuic acid showed particularly strong effect against Serratia marcescens and Enterobacter cloacae. The IC50 and IC90 for the compounds determined by the micro titer plate method indicated that trigonelline; caffeine and protocatechuic acids are potential natural antimicrobial agents against Salmonella enterica. The concentrations of caffeine found in coffee extracts are enough to warrant 50% of the ant microbial effect against S. enterica, which is relevant to human safety. (J. Agric. Food Chem., 54 (23), 8738-8743, 2006. 10.1021/jf0617317 S0021-8561(06)01731-6 Web Release Date: Oct. 24, 2006)

11. Studied effect of Rooibos has anti-carcinogenic and antimutagenic effects. Rooibos tea is used for its anti-inflammatory and anti-allergic properties. Consumption of rooibos tea may relief fever, asthma, insomnia, colic in infants and skin disorders. Rooibos extracts are used in ointments against eczema. In South Africa it is very common to give rooibos tea to babies who suffer from stomach cramps (colic). Rooibos is the only known source of the phytochemical aspalathin. In vitro and animal studies have indicated that quercetin and luteolin help to prevent cardiovascular disease, some cancers and stroke. Rutin has been associated with the maintenance of blood vessels walls. Because rooibos contains no caffeine, it is suited for babies and children. The low level of tannins in rooibos will prevent problems with iron absorption. The clastogen-suppressing effects of green tea, Po-lei tea and Rooibos tea in CHO cells and mice that fermented rooibos tea reduced cancer-associated changes in animal cells induced by the certain mutagens both in vitro and in vivo. Other researchers found that rooibos extracts from fermented rooibos leaves reduced cancerous transformation of mouse cells irradiation with x-rays. They found that extracts from unfermented green rooibos tea did not show this protective effect. (Sasaki Y F et all (Mutat Res 1993;286:221-232)

Advantages and embodiments of this invention are further illustrated but not limited to the use of the following plant families and their commonly referred to names. Coffee and tea grounds can be derived from Rubiaceae plants or coffee family, Camellia sinensis, Theaceae family, Tisane, or ptisan herbal infusion, Aspalathus linearis or Rooibos Plants.

Then coffee and tea grounds are mixed with any form of vegetable oils or animal fats to produce said coffee and tea baking compound. The compound is then formulated into a dough or batter using conventional baking methods. Polyphenols that are naturally derived from coffee and tea are key components in the development of flavor formation during the Maillard reaction (MR). Polyphenols inhibit the (MR) reaction by tying up or quenching some of the sugars and other transient reaction products the process needs to proceed. Polyphenols can reduce levels of acrylamide found in starch foods during baking unexpectedly high levels of acrylamide, found to cause cancer in laboratory rats, in carbohydrate-rich foods. Polyphenols slow down the rate oxidative deterioration of the baking compound and baked goods extending shelf life and storage without increasing cost. Polyphenols reduce oxidative coupling that also occur during baking which helps preserve aroma compound found in coffee. Polyphenols in coffee and tea plants posses a wide range of beneficial pharmacological activities which include stabilizing the capillary wall tissues, quenching free radicals, maintaining proper permeability and flexibility of capillaries and preventing cardiovascular diseases. Polyphenols “catechins” are associated with reduced risk of stomach, colon and other gastrointestinal cancers adding ascorbic acid to the baking formula. This can protect catechins from digestive degradation.

Tea compounds that are derived from Rooibos are the only known source of phytochemical aspalathin. In vitro and animal studies have indicated that quercetin and luteolin help to prevent cardiovascular disease, some cancers and stroke. Rutin has been associated with the maintenance of blood vessels walls.

Phenolic acids found in the coffee compounds are mainly esters of quinic acid with different amount of caffeyl groups attached to its different positions. The phenolic acids present in coffee such as chlorogenic acid, caffeic acid and para-coumaric acid have been shown to exert cancer preventive activities in animal models. Chlorogenic acid has also been found too.

Flavor oils like coffee ester triglycerides and other compounds found in coffee concentrations have known to form microbial trigonelline, caffeine and protocatechuic acids are potential natural antimicrobial agents against Salmonella enterica.

The concentrations of caffeine found in coffee extracts are enough to warrant 50 percent of the antimicrobial effect against S. enterica, which is relevant to human safety.

Traditionally coffee and tea grounds have been combined with other dry ingredients when used in baked goods or foodstuff. During the (MR) reaction the acids from the coffee and tea start to burn off before non-enzymatic browning forms. The increased carbon activity breakdown the starches in the flour and the cellulose absorb any liquid available leaving the baked product dry, greasy and fragmented. The present invention solves this problem by incorporating fatty acids from either coffee or tea and blending them with vegetable oils or animal fats creating a bond that is water-soluble. This bonding effect solidifies fatty acids, absorbs carbons, polyphenols and other volatile and non-volatile compounds found in coffee and tea.

Most natural fats found in plants and animals contain a complex mixture of individual triglycerides; because of this, they melt over a broad range of temperatures. The triglycerides found in coffee, tea, vegetable oils, butter and other animals fats are composed of the same or similar complexity. This gives them a relative melting point allowing them to bond together at carbon levels were they are esterfied. Esterification takes place in the oven this chemical reaction in which two reactants sugars and acids form esters this increases the depth of flavor of the finish product. Esterifications are among the simplest and most often performed organic transformations making it an easy transition into the coffee and tea baking compound formula.

The Japanese have used matcha tea powder it in ceremonial cooking for centuries, enjoying its health benefits as a herb by eating, baking and cooking with it. In fact, since only one-third of tea's nutrients and beneficial ingredients are soluble in (cold and hot) water, the remainders of these ingredients are discarded. Green tea consists of 35% water-soluble ingredients (such as catechins, caffeine, amino acids and water-soluble vitamins) and 65% non-water-soluble ingredients like fiber, vitamin E, carotene protein, chlorophyll and others. The possible beneficial health effects of tea consumption have been suggested and supported by many studies. The vast majority of studies have been of green tea, however, some studies have been made of the other types of tea derived from Camellia sinensis such as white, oolong and black tea. Green tea has been claimed to be helpful for atherosclerosis, LDL cholesterol, cancer, inflammatory bowel disease, diabetes, liver disease, weight loss, neurodegenerative diseases and halitosis.

Rooibos tea originates from the leaves and stems of the indigenous South African plant Aspalathus linearis and contains no caffeine. It has been described as having a fruity, nutty flavor well suited for baking. Rooibos tea is also known as Red-Bush and grows on high mountain ranges. Rooibos has gained much attention for clinical purposes in the case of nervous tension, allergies (dermatitis) and various digestive problems. Recently, antioxidant activity has also been attributed to the tea on the basis of its flavonoid content. The main flavonoids in rooibos are dihydrochalcone aspalthin, rutin, and orientin. Another flavonoid is rooibos herb is chrysoeriol (luteolin 3′-methyl ether). This flavonoid is known for antioxidant, anti-inflammatory, antitumor, anti-microbial and antiviral properties. Because rooibos contains no caffeine, it is suited for babies and children. The low level of tannins in rooibos will prevent problems with iron absorption.

The present inventor has discovered that if applied in the manner prescribed herein, the remarkably simple process of grinding coffee or tea then mixing with vegetable oil to produce a tea and baking compound when mixed with common baking ingredients will produce baked goods that are rich in polyphenols that preserve aromatic flavors with increased product life and means for delivering health-enhancing agents to consumers in a most non-intrusive and cost effective manner. The process of the present invention when compared with earlier related processes, developed by the present inventor, not only provides substantial health benefits potential, but permits such benefits to be realized, and the product which carries the benefits to be distributed and sold, with no market or distribution related impediments or inconveniences. This is true in part because unlike some of the referenced prior processes (coffee extracts) the realization of a completed coffee and tea baked product has been developed. All flavor development can be done from the roaster to the baker combining the two arts and science dubbing it “barista baker”.

Illustrative examples of processes of the present invention follow. It should be understood of course that commercial processing according to the present invention will take place on much larger scales than the illustrative examples provided with proportional increases in the respective constituents (Coffee flavor roasting profiles and quantity and textures to conform to band size ovens).

According to the most economical version of the present invention, 18 (g) of the freshest french roast coffee beans (grind to a Turkish grind) are sifted with a tight knit sifter into 58 (g) of crisco like vegetable oil in a mixer blending until the oils form together and the dry material “cellulose” is blended in. (about 1 to 2 min on low speed mixer, or 2 minutes by hand). The compound is formed when color is consistently black or brown throughout.

### EXAMPLES

### Example 1

26 (g) fresh ground french roast is ground to a (turkish grind burr grinder) is sifted into 94 (g) of shortening then mixed for 2 minutes on low speed mixer. Continue mixing by hand until coffee grounds are througly blended in. The compound is formed and is ready to be used in conjunction with other ingredients to form cookies or it can sealed and stored at roon tempature, refigerated or frozen.

### Example 2

“DarkRoast Coffee Cookie” Measure out 7 Tbps. butter, 4 Tbsp. Shortening and combine in a bowl. Grind 19 g of the freshest beans (must be fully developed grease french roast) grind to a turkish grind (burr grinder), sift and combine in a bowl mix until all of the coffee is fully blended, about 2 minutes slowly. Add ½ cup brown sugar, ¼ cup white sugar and blend well. Combine 1 medium or small egg and mix. Add vanilla and mix. Combine 1½ cups all purpose flour with ½ tsp baking soda and ½ tsp salt in a separate bowl and mix well. While mixing slowly, add dry ingredients (dough should be wet, add a little water is needed). Stir in ¾ cup dark chocolate. Prefered method is to use parchment paper. Spoon onto a cookie sheet and bake at 350 degress F. for 8-12 minutes or until brown on the edges. Ready to eat.
If you omit the chocolate chips this is the flavor pallet you should enjoy: honey, carmel like, earthy, buttery, vanilla, spicy and chocolate.

### Example 3

“Chocolate Carmel Macchiato” Add compound from example 1 to mixing bowl then add ⅛ tsp liquid soy lecithin, ½ cup brown sugar, ¼ cup white sugar and blend until smooth. Add 2 Tbls vanilla extract, blend. Stir in ⅛ cup of coffee extract (Toddy method (no filter plug) with sweet espresso grounds. Let stand for 24 hours then drain into a carafe) and mix in to batter. Combine 125 (g) flour with ½ tsp baking soda, ½ tsp salt and mix together. Slowly add dry ingredient to wet. (dough should be wet, add a tsp of water at time if needed) Add ⅓ cup semi sweet chocolate chips and blend. Scoop dough onto parchment paper and top with very small pieces of soft carmel and bake at 360 degress until cookies start to brown slightly on the sides, 8-12 minutes. Cookies will have a rich coffee chocolate and sweet flavor.

### Example 4

“Herbal Lemon Ginger Vegan Tea Cookie” Grind 11 g of lemon ginger tea with a blade grinder until powdered. Sift into 94 g of non hygrogenated vegetable shortening and blend througly. Add ⅛ tsp. of liquid soy lecithin, mix. Add 150 g sugar and mix in 1 Tbls vanilla extract. Mix in ¼ cup of water. Combine 150 g flour with ½ tsp baking soda and ½ salt, mix. Add dry ingredients to form a dough. Scoop onto parchment paper then bake at 360 degree oven until edges are brown, 8-12 minutes. Texture and flavor is smilar to a gingersnap with no animal products used.

### Example 5

“Lap Sang Sauchong Spiced Latte Cookie” Grind 7 g organic lap sang sauchong tea to a powder and add to 94 g of non hygrogenated shortening, combine. Mix ½ white sugar and ⅛ cup brown sugar and mix well. Add 2 Tbls vanilla extract and mix. Combine 130 g flour with ½ tsp baking soda, ½ tsp salt, ⅓ tsp ground ginger, ½ tsp of cinnamon, ¼ tsp cardamon and ⅛ tsp clove. Blend dry ingredients together then add slowly to wet ingredients until dough is formed. Scoop onto parchment paper and bake at 360 for 8-12 minutes.

### Example 6

“Espresso Cake” Add 1 cup of shortening to 12 g of ground french roast coffee (Turkish grind). Stir into shortening and blend on slow speed for 1 minute, then on medium speed for 90 seconds. Add ¾ cup of white sugar, 2 Tlbs of vanilla, combine. Combine ¾ cup of self rising flour and 2 Tbls of cocoa powder, ½ tps of baking powder and ½ tps salt. Slowly add ¼ cup+2 Tbls of coffee extract at the same time you add dry ingredients alternating back and forth until it is smooth. Beat in one large egg for 1 minute. Pour into 8″ round greased and floured cake pan. Bake at 355 degrees for 25-30 minutes.

### Example 7

“Coffee Cookie with canola oil” Combine 11 Tbls of canola oil with 28 g of sifted french roast coffee, blend and let coffee saturate for 2 minutes. Add ½ cup brown sugar, ¼ cup white sugar, ⅛ cup milk, and 2 Tbls vanilla extract. Combine 150 g flour, ½ tsp baking soda and ½ tsp salt, mix well. Combine dry ingredients with wet until dough forms. Scoop onto parchment paper and bake at 360 degrees for 8-12 minutes. This cookie when hermetically sealed and flash frozen can be stored for up to 3 months while still retaining its fresh coffee flavor.

Although the invention has been described with examples 1-7 to specific embodiments this description is not meant to be construed in a limited sense. An array of baked goods can be derived from the ingredients used, but not limited to examples 1-7, including yeast to form breads.

Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

I claim:

1. A method and process for producing said coffee or tea compounds that comprise of the following steps of selecting said coffee or tea then reducing them to a fine grind or powder then combining said fine grinds or powder with said vegetable oils or animals fats blending or mixing until said coffee or tea compounds are formed.

2. The method of claim 1. Wherein the coffee and tea compounds are expressed to develop said foodstuffs.

3. Method according to any of claims 1 or 2 wherein vegetable oils animal fats, sugars, flours, extracts, water, milk, eggs, lecithin, yeast, spices, herbs, salts, baking soda and other volatile or non volatile compounds may be used to comprise said dough's, batters or any said food stuff.

4. Method according to any of claims 1 to 3, wherein the dough or batter is processed to produce baked goods or said foodstuff then baked.

5. Method according to any of claims 1 to 4, wherein the natural availability of polyphenols in said coffee or tea compounds developed a lower level of Maillard reaction type aroma compounds.

6. Method according to any of claims 1 to 5, wherein composition of said baked foodstuffs containing polyphenols increase shelf life of said baked goods or foodstuffs.

7. A method according to any of claims 1 to 6 wherien coffee and tea compounds stabilize the aroma of aroma-rich foodstuffs and their products by reducing oxygen levels controlling pH levels contained therein.

8. A method according to claim 5, wherein compounds exert their cancer protective effects during and after baking of said bake goods and foodstuff.

9. A method according to claims 1 to 5, wherein a stable improvement of textures of baked products and foodstuff.

10. A method according to claims 1 to 5, wherein ascorbic acid or citrus added to dough's, batters and foodstuff protect catechins from digestive degradation.

11. A method according to claims 1 to 2, wherein polyphenols increase shelf life of said coffee or tea compounds from flavor degradation, ramification.
